(19) United States
(12) Patent Application Publication
(10) Pub. No.: US 2003/0135408 A1
(43) Pub. Date: Jul. 17, 2003

(54) Methods and apparatus for providing an interactive backdrop with real time variable advertising content

(76) Inventor: Daniel M. Snyder, Bethesda, MD (US)

Correspondence Address: PRIEST & GOLDSTEIN PLLC, 5015 SOUTHPARK DRIVE, SUITE 230, DURHAM, NC, 27713-7736, US

(21) Appl. No.: 09/683,489

(22) Filed: Jan. 7, 2002

(51) Int. Cl. G06F 17/60

(52) U.S. Cl. 705/14

(57) ABSTRACT

A dynamically variable press conference backdrop is described. This backdrop may be part of a portable system which a sports team or the like might use to conduct press conferences after road games, or as a fixed system which would be used in an environment such as a pro-sports team's home stadium or the like. The dynamic backdrop provides a multitude of new sponsorship opportunities, team marketing opportunities, the ability to allow speakers to interact with the backdrop, for example, with video footage from the game preceding the press conference, and the like.

### BACKGROUND OF INVENTION

The present invention relates generally to improvements in backdrops, such as those used for press conferences, for example, where a sports figure, such as a coach or player, is interviewed after a sporting event. More particularly, the present invention relates to advantageous methods and apparatus for providing an interactive or dynamic backdrop with a real time variable display for displaying variable advertising content and the like.

There are a wide variety of events in which the media is focused on a speaker or speakers. By way of example, sports press conferences follow almost all significant sporting events. Post-game interviews of coaches or starring players occur regularly after NCAA Final Four T™ games, professional football games, professional basketball games and the like. In such interviews, it is common for the person to be interviewed to be standing at a podium or sitting at a press table in front of a backdrop. With television cameras rolling and photographs being taken, it is common for this background to be camera friendly so that good quality video and photographs result. The backdrops can be formed from a variety of materials, such as a sheet of canvas, vinyl, or the like, or can be formed by a painted wall or some other more or less fixed background depending upon the media facilities at any given locale. All of these backgrounds, however are static and do not change during the course of an interview.

While the level of media attention is highly variable depending upon various factors such as the team, its media market, the importance of the event, and the like, a marketing opportunity is created by the media attention. After the Super Bowl™ or some other major event, the eyes of the nation and of much of the world may be focused on a post-game press conference. On the other hand, after a preseason game, the level of interest may be much smaller and limited to a team's local media market. In recognition of the opportunity presented by such media focus, team or organization logos may be prepared in advance and may be part of any of the above described static backdrops. It has also been recognized that sponsor logos may be added to these static backdrops. Thus, for example, a coach of a professional football team may be interviewed in front of a green backdrop with a team logo fixed thereon and a sponsor logo, such as FedEx™ or the like, may also be fixed thereon.

### SUMMARY OF INVENTION

The present invention recognizes that such approaches do not take full advantage of the many and variable marketing opportunities presented by post-game conferences and the like. Further, static backdrops do not provide the ability to dynamically vary the backdrop in real time. By way of example, where two teams are being interviewed in the same press area after a game, with a static backdrop, they must either share the same backdrop or they must have their own backdrop made up in advance and then change it very quickly between interviews. Neither option is particularly appealing, and in either case, there is no opportunity to change the backdrop as an extended interview proceeds so that a potentially huge marketing opportunity is squandered.

With a dynamically variable backdrop as taught by the present invention, a host of advantages not achievable with a static backdrop can be readily achieved. According to one aspect of the present invention, an interactive or dynamic backdrop is provided for press conferences. Interactive logos and messages can be displayed behind the person participating in the press conference. These messages can be varied throughout the press conference to provide different messages for different sponsoring companies, to highlight the logos of different teams or sponsors, or any other type of information may be dynamically displayed and changed as desired while the press conference is in progress.

According to another aspect of the invention, a portable system is provided that can be transported easily from location to location on short notice. This system can take information from various inputs, such a computer, a digital video disk (DVD) player, a video cassette recorder (VCR), or the like.

By way of example, with a dynamic backdrop in accordance with the present invention, a variable text message as controlled by a video controller, such as a personal computer (PC), can be displayed along with the logo of a sponsoring company. Additionally, both a PC driven display and an additional video display can be utilized together. Thus, in the case of the Washington Redskins who have a sponsorship program with Papa John's™ pizza in which a customer gets a dollar off on a pizza ordered after a Redskins' game that the Redskins' win or a dollar off for each Redskins' touchdown, a logo for Papa John's™ pizza can be displayed along with a phone number or phone numbers to call to order pizza, as well as, a video replay of each of the Redskins' touchdowns.

Sponsorship opportunities can be subdivided on a time basis so that each sponsor is on the backdrop for two minutes, a minute, thirty seconds, or whatever time has been agreed upon. Alternatively, multiple sponsor logos can be displayed at the same time along with a team logo. A team's ticket information can also be displayed. Thus, where a team qualifies for the playoffs, timely ticket information including phone numbers, locations to obtain tickets, the cost of tickets, and when tickets will be available can be provided to a team's fans. The possibilities are myriad.

These and other advantages of the present invention will be apparent from the drawings and the Detailed Description which follows below.

### BRIEF DESCRIPTION OF DRAWINGS

FIG. 1 illustrates a front view of one embodiment of a portable interactive backdrop in accordance with the present invention;

FIG. 2 illustrates a perspective view of the interactive backdrop of FIG. 1;

FIGS. 3A and 3B illustrate details of a trunk for one of the stands for the plasma display of the interactive backdrop of FIG. 1;

FIGS. 4A and 4B illustrate details of a trunk suitable for transporting one of the plasma displays of the interactive backdrop in a portable system in accordance with the present invention;

FIG. 5 is a flowchart illustrating a method for providing an interactive backdrop with real time variable advertising content in accordance with the present invention; and

FIG. 6 shows an alternative embodiment of a backdrop in accordance with the present invention for press conferences in a fixed location.

### DETAILED DESCRIPTION

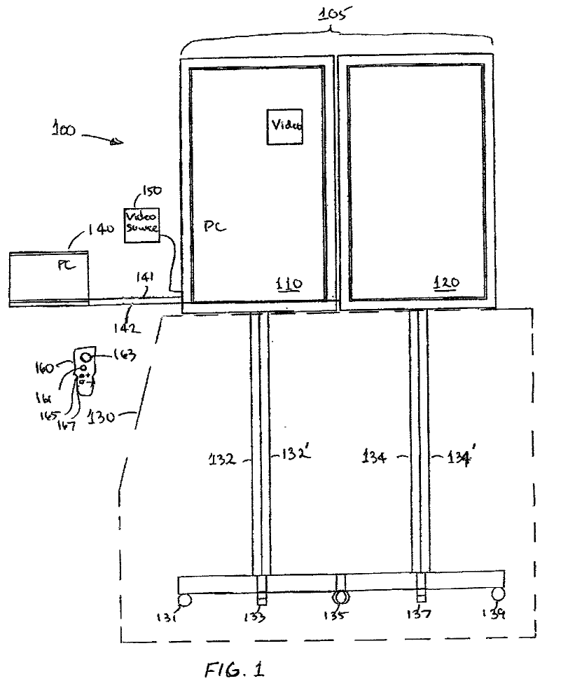

FIG. 1 illustrates an embodiment of an interactive backdrop 100 in accordance with the present invention. As shown in FIG. 1, backdrop 100 includes a display 105, supported by a movable stand 130 and a control computer 140. In a presently preferred embodiment, the display 105 may be suitably embodied as two display monitors 110 and 120. Exemplary monitors are the NEC Plasma Sync™ 61 inch plasma display monitors model number NCPX61 XM1A which are mounted on stand 130 so that their large dimension is vertically oriented. It will be recognized that while throughout this disclosure particular components for a prototype system in accordance with the present invention are described, other alternative components may also be employed. For example, as larger plasma screens are developed and become less expensive with time, it will be recognized that the two monitors 110 and 120 could be replaced by a single larger monitor. Alternatively, while two monitors are shown, it will be recognized that a larger number of monitors of the same size could be employed to make a larger backdrop. Similarly, while a plasma type display is presently preferred, it will be recognized that alternative types of displays may also be employed, and that will be particularly true if new display technologies are developed which surpass those presently in use.

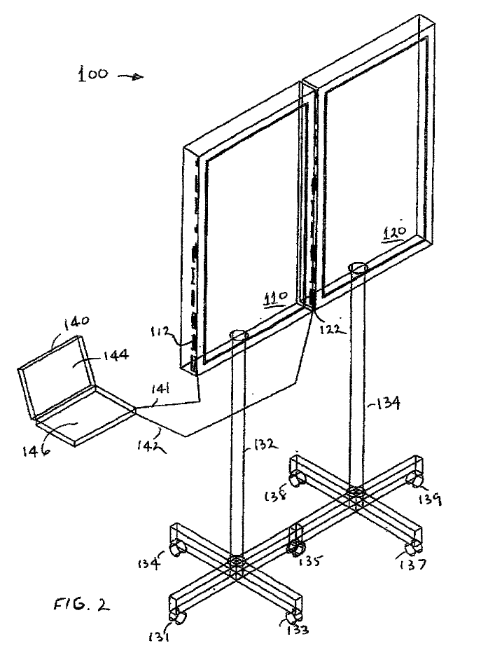

Returning to movable stand 130, at present, it is preferred to form this stand from two Chief PTC-43 61 inch plasma monitor carts or stands model number CFPTC43 which are used as indicated above to mount the monitors in a vertical configuration. These carts have casters 131, 133, 135, 137 and 139, as seen in the front view of FIG. 1, with additional casters 134 and 138, as seen in the perspective view of FIG. 2. Each of the carts also includes two mounting poles 132 and 132′ or 134 and 134′ as also seen in FIG. 1.

Computer 140 is connected to input panels 112 and 122 of monitors 110 and 120 by video input connectors 141 and 142, respectively. An exemplary computer suitable for use as the computer 140 is the Sony Vaio™ video graphic laptop computer model number PCG-GR290K. The computer 140 is used to produce the image and any desired background color areas on the monitors 110 and 120. The input panels of the NEC Plasma Sync™ monitors include connections allowing the user to connect signals from virtually any input source including a computer, any conventional video source, or an HDTV source. These monitors have split screen display capability allowing the simultaneous display of video from multiple input sources, such as a computer and a second additional video source. Thus, as illustrated in FIG. 1, a video source 150 supplies video signals which control the display of a portion of the screen of monitor 110 labeled Video and PC 140 supplies the signals driving the remainder of the screen of monitor 110, the portion labeled PC. Thus, by way of example, the bulk of the PC portion of the screen might be driven by the input signals from PC 140 to provide a green backdrop for a coach or player doing a post-game interview in front of backdrop 100. This PC portion might also display the logo of Papa John's™ pizza, text explaining a special product offer, such as one dollar off for each Redskins' touchdown scored in the game, and a phone number or numbers. Simultaneously, the video portion might show replay footage of the Redskins' touchdowns during the game.

Alternatively, video footage in the Video portion of the display could be related to game highlights being addressed by interviewers at the press conference. The NEC Plasma Sync™ monitors include a remote control, such as remote control 160, shown in FIG. 1. This remote control 160 can be connected to the monitor or operate wirelessly as desired by the user. Utilizing a pointer button 161, a player or coach can activate a pointer on the display. Using a cursor adjuster button 163, the pointer can be adjusted and using zoom in and zoom out buttons 165 and 167, the action pointed to can be zoomed in on or out from, respectively. Such features, as well as others, are described in further detail in the NEC Technologies Plasma Sync™ 61 MP1 User's Manual which is incorporated by reference herein in its entirety. The dynamic backdrop of the present invention makes possible a host of advantages not achievable by prior art static backdrops.

The desired image or images to be displayed on the monitors 110 and 120 can be produced using a number of alternative software packages including, but not limited to, CD-RW/DVD, Microsoft PowerPoint™ software or the like. In addition, because the monitors are vertically mounted in an orientation also referred to as a portrait display mount, software to rotate the images is also preferably included. Suitable software is the Pivot™ software by Portrait Displays which allows the orientation of the image portrayed on the plasma monitors 110 and 120 to be rotated by varying degrees such as 90°, 180°, 270° and landscape. For the vertical mounting presently preferred, 90° rotation is advantageously utilized.

The embodiment of the interactive backdrop 100 of FIGS. 1 and 2 is designed to be portable. Thus, it may be readily taken apart, packed for shipping or transport, and then reassembled. For example, an NFL football team could readily use the backdrop 100 for post-game press conferences when that team is traveling to an away game. To this end, it is presently preferred that a portable system in accordance with the present invention also includes protective shipping or transport containers for both the displays 110 and 120 and the stand 130.

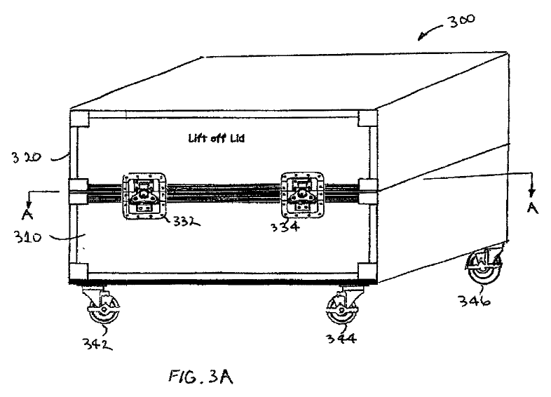

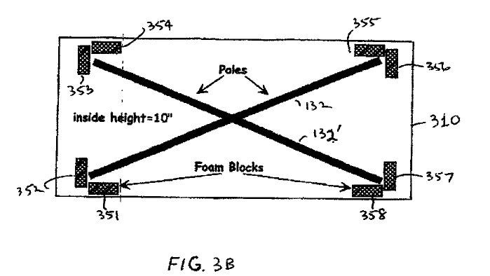

FIGS. 3A and 3B show different views of an exemplary trunk 300 for packing one of the two Chief PTC-43 mobile carts making up the presently preferred stand 130. Thus, in an overall portable system, there would be two trunks 300, one for each of the two carts. FIG. 3A shows a front perspective view of the trunk 300. A presently preferred trunk is a Viking custom ATA case model number VKCUSTCHIEFPTC43. This case has a height of approximately 16½ inches, a width of approximately 68 inches and a depth of approximately 33 inches. The trunk 300 preferably includes a plurality of casters 343, 344 and 346 so it can be easily rolled. A fourth caster is not seen in the perspective view of FIG. 3A. Trunk 300 also includes latches 332 and 334 to secure the closure of the trunk. The casters 343, 344 and 346 are attached to the bottom of a base portion or trunk bottom 310 and a lift off lid 320 is attached in place by the latches 332 and 334.

FIG. 3B shows a top inside view along section line AA of FIG. 3A illustrating the inside of the base portion 310. Foam blocks 351-358 are attached in the corners of the base 310 so that poles 132 and 132′ or alternatively poles 134 and 134′ can be safely stowed crosswise in the trunk 300. The interior of the trunk 300 is also preferably Ozite lined.

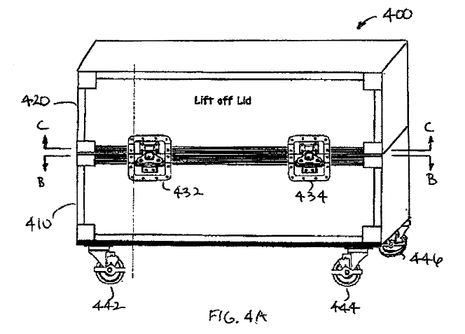

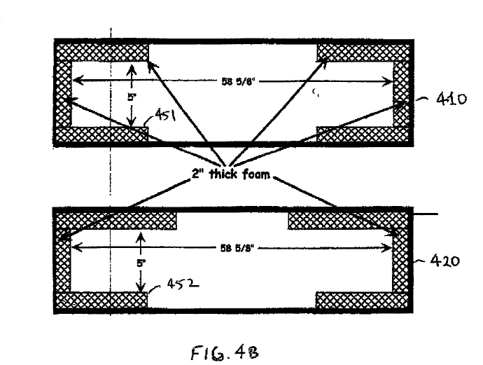

FIGS. 4A and 4B show different views of an exemplary trunk 400 for packing one of the NEC Plasma Sync™ 61 inch monitors. Thus, in the overall portable system, there would be two trunks 400, one for each of the displays. FIG. 4A shows a front perspective view of the trunk 400. A presently preferred trunk is the Viking custom ATA case model number VKCUSTNECPX61XM1A. This case has a height of approximately 47 inches, a width of approximately 65 inches and a depth of approximately 10 inches. As was the case for the trunk 300, trunk 400 preferably includes a plurality of casters 442, 444 and 446 with a fourth caster not seen in FIG. 4A. Trunk 400 also includes latches 432 and 434 to secure the closure of the trunk. The casters 442, 444 and 446 are attached to the bottom of a base portion or trunk bottom 410 and a lift off lid 420 is latched in place by the latches 432 and 434.

FIG. 4B shows top inside views of bottom 410 and lift off lid 420 along section lines BB and CC of FIG. 4A, respectively. A two inch thick foam lining 451 and 452 lines much of the interior wall of the bottom 410 and the lid 420, respectively. The interior bottom wall of bottom 410 and the interior top wall of lid 420 are also preferably lined with foam approximately five inches thick.

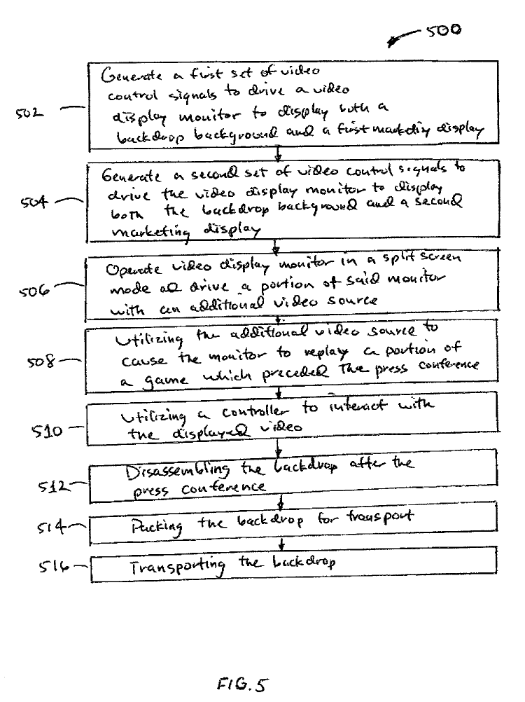

FIG. 5 shows a method of dynamically varying a press conference backdrop 500 in accordance with the present invention. In step 502, a computer video controller, such as PC 140, generates at a first time a first set of video control signals to drive a video display monitor or monitors utilized as a press conference backdrop, such as either or both of the display monitors 110 or 120, to display both a backdrop background and a first marketing display, such as a logo, a text message or the like. The backdrop background will typically be a camera friendly solid color such as green, for example. In step 504, the computer video controller generates at a second time a second set of video control signals to drive the video display monitor or monitors utilized as the press conference backdrop to display both the backdrop background color and a second marketing display differing from the first marketing display. By way of example, in an extended press conference, multiple sponsorship opportunities might be sold just as advertising is sold in blocks of thirty seconds, a minute, or longer, as desired.

Thus, the first marketing display may be displayed for a first predetermined time determined by the computer video controller and then the second marketing display is displayed for its predetermined time. In step 506, the display monitor is operated in a split screen mode and an additional video source is utilized to generate an additional set of video signals to drive a portion of the display monitor separately from the portion driven by the computer video controller. In step 508, the additional video source is utilized to generate video signals causing a display on the monitor of a replay of a portion of a game which preceded the press conference. In step 510, a person being interviewed during the press conference utilizes a controller to interact with the displayed video. For example, a pointer may be utilized by the interviewer, a zoom in or zoom out feature may be utilized, or some other interaction may be employed. In step 512, the backdrop is disassembled after the press conference. In step 514, the backdrop is packed for transport and in step 516, the backdrop is transported.

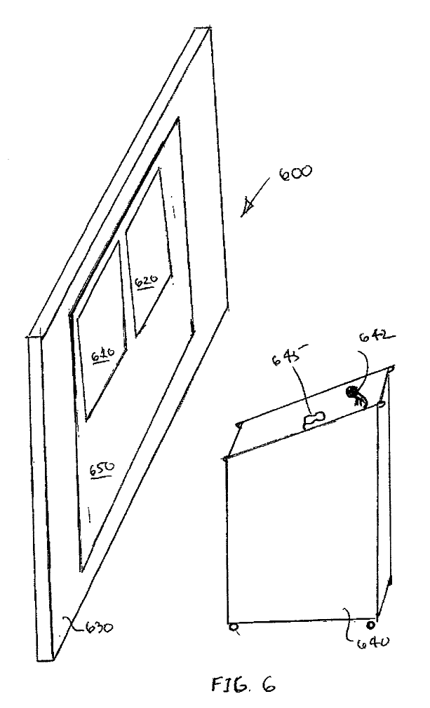

FIG. 6 shows an alternative embodiment of the present invention in which a fixed interactive or dynamic backdrop 600 is employed. As shown in FIG. 6, two electronically controlled video displays 610 and 620 are built into a wall 630 behind a podium 640 at which a speaker to be interviewed in a press conference would stand. Podium 640 includes a microphone 642 and a display controller 645.

In addition, the backdrop 600 includes a matte or mask member 650 which might be a vinyl sheet attached to the wall 620 by Velcro™ fasteners or in some other manner. Mask member 650 is preferably the color desired for the backdrop, for example green, and accurately matches the backdrop color to be displayed by the monitors 610 and 620 during the press conference. The mask 650 includes cutouts dimensioned so that the mask 650 does not cover up the actual display portions of the monitors 610 and 620, but so it will cover the portions of the housings of these monitors which surround the actual display area so that except for any marketing displays, video displays or the like, a uniform backdrop background color is presented. Thus, the backdrop 600 looks like a static backdrop except that dynamic display capability has been added. A video computer control, video source and the like not shown in FIG. 6 for ease of illustration, can be advantageously located in a control room behind wall 620, for example. Operation of monitors 610 and 620 is similar to that of monitors 110 and 120 of FIG. 1. Similarly, although not shown in FIGS. 1 and 2 for clarity of illustration, a matte, or mask member can be employed with system 100 so that both the monitor housing and mobile monitor carts are hidden from the view of those looking at the speaker.

While the present invention has been described in the context of presently preferred embodiments, it will be recognized that a number of variations will be apparent to those of ordinary skill in the art and that the present techniques may be readily adapted and applied to various environments consistent with the foregoing disclosure and the claims which follow.

1. A method for providing a dynamically variable backdrop for a press conference comprising the steps of:
generating at a first time a first set of video control signals to drive a video display monitor utilized as a press conference backdrop to display both a backdrop background and a first marketing display; and
generating at a second time a second set of video control signals to drive the video display monitor to display both the backdrop background and a second marketing display different from the first marketing display.

2. The method of claim 1 further comprising the step of:
operating the video display monitor in a split screen mode and utilizing an additional video source to generate an additional set of video signals to drive a portion of the display monitor separately from the portion driven by the first set of video control signals.

3. The method of claim 2 wherein the additional video source is utilized to generate video signals causing a display on the display monitor of a replay of a portion of a game which preceded the press conference.

4. The method of claim 1 further comprising the step of:
utilizing a controller to interact with the video display monitor in real time.

5. The method of claim 1 further comprising the step of:
disassembling the press conference backdrop after the press conference is completed.

6. The method of claim 1 further comprising the step of:
packing the press conference backdrop in a protective transport container.

7. The method of claim 6 further comprising the step of:
transporting the press conference backdrop packed in the protective container.

8. The method of claim 1 wherein the backdrop background is a solid color and the first marketing display is a team logo, a sponsor logo, a text message or some combination thereof.

9. The method of claim 1 wherein the first marketing display is a paid sponsor message which is displayed for a first predetermined period of time.

10. The method of claim 9 wherein the second marketing display is a paid sponsor message which is displayed for a second predetermined time.

11. The method of claim 1 wherein the first marketing display is a team logo or a text message promoting a team's ticket sales.

12. The method of claim 3 further comprising the step of:
utilizing a controller by a speaker being interviewed in the press conference to interact with the replay of a portion of the game.

13. The method of claim 4 wherein said interaction comprising controlling a pointer on the video display or zooming in or zooming out from a selected area of the video display.

14. The method of claim 1 further comprising the step of:
forming the press conference backdrop from two or more video display monitors.

15. The method of claim 14 further comprising the step of:
utilizing a mask member having coloration consistent with the backdrop background to overlay portions of housings of the monitors to present a consistent and visually uninterrupted backdrop background.

16. Apparatus for providing a dynamically variable backdrop for a press conference comprising:
means for generating at a first time a first set of video control signals to drive a video display monitor utilized as a press conference backdrop to display both a backdrop background and a first marketing display; and
means for generating at a second time a second set of video control signals to drive the video display monitor to display both the backdrop background and a second marketing display different from the first marketing display.

17. The apparatus of claim 16 further comprising:
means for causing the video display monitor to operate in a split screen mode and an additional video source to generate an additional set of video signals to drive a portion of the display monitor separately from the portion driven by the first set of video control signals.

18. The apparatus of claim 17 wherein the additional video source is utilized to generate video signals causing a display on the display monitor of a replay of a portion of a game which preceded the press conference.

19. The apparatus of claim 16 further comprising:
a controller allowing a user to interact with the video display monitor in real time.

20. The apparatus of claim 16 further comprising:
a mobile cart for supporting the video display monitor in a manner whereby said apparatus can be readily disassembled after the press conference is completed.

21. The apparatus of claim 16 further comprising:
a protective transport container for packing the press conference backdrop for shipping.

22. The apparatus of claim 16 wherein the backdrop background is a solid color and the first marketing display is a team logo, a sponsor logo, a text message or some combination thereof.

23. The apparatus of claim 16 wherein the first marketing display is a paid sponsor message which is displayed for a first predetermined period of time.

24. The apparatus of claim 23 wherein the second marketing display is a paid sponsor message which is displayed for a second predetermined time.

25. The apparatus of claim 16 wherein the first marketing display is a team logo or a text message promoting a team's ticket sales.

26. The apparatus of claim 18 further comprising:
a controller utilized by a speaker being interviewed in the press conference to interact with the replay of a portion of the game.

27. The apparatus of claim 19 wherein the controller allows the speaker to control a pointer on the video display or to zoom in or zoom out from a speaker in a selected area of the video display.

28. The apparatus of claim 16 wherein the press conference backdrop is formed from two or more video display monitors.

29. The apparatus of claim 28 further comprising:
a mask member having coloration consistent with the backdrop background to overlay portions of housings of the monitors to present a consistent and visually uninterrupted backdrop background.

30. A portable system for providing a dynamically variable backdrop for a press conference comprising:
a dynamically variable display comprising a plasma display monitor having an input panel;
a video computer control signal generator connected to the input panel and providing a video signal to control the plasma display monitor, said video computer programmed to generate a background backdrop suitable for use as a backdrop for a press conference for display over the bulk of the surface of the plasma display monitor and to generate an advertising indicia for display over a smaller portion of the surface of the display monitor; and
a support to hold the plasma display monitor in a desired location behind a speaker to be interviewed in the press conference.

31. The system of claim 30 wherein said support is a plasma display holding mobile cart.

32. The system of claim 31 further comprising a protective shipping trunk for the plasma display monitor and a protective shipping trunk for the plasma display holding mobile cart.

33. The system of claim 30 wherein the dynamically variable display comprises at least two plasma display monitors arranged side by side.

34. The system of claim 30 wherein the dynamically variable display comprises at least two plasma display monitors arranged vertically side by side.

35. The system of claim 30 further comprising:
an additional video signal input device.

36. A method for providing a dynamically variable backdrop comprising the steps of:
generating at a first time a first set of video control signals to drive a video display monitor utilized as a backdrop to display both a backdrop background and a first marketing display; and
generating at a second time a second set of video control signals to drive the video display monitor to display both the backdrop background and a second marketing display different from the first marketing display.
